(19) United States
(12) Patent Application Publication
(10) Pub. No.: US 2008/0143515 A1
(43) Pub. Date: Jun. 19, 2008

(54) Information technology system for health care environments

(75) Inventors: Billy J. Wood, Boulder, CO (US); Ray Jones, Longmont, CO (US); Jerry A. Klinz, Longmont, CO (US)

Correspondence Address: Attention of John C. Reich;MERCHANT & GOULD P.C, P.O. Box 2903, Minneapolis, MN, 55402-0903, US

(73) Assignee: Colorado MEDtech, Inc., Boulder, CO (US)

(21) Appl. No.: 11/975,684

(22) Filed: Oct. 19, 2007

Related U.S. Application Data
(63) Continuation of application No. 10/161,168, filed on May 31, 2002, now abandoned.
(60) Provisional application No. 60/295,181, filed on Jun. 1, 2001.

(51) Int. Cl. G08B 1/08; H04Q 7/00

(52) U.S. Cl. 340/539.12

(57) ABSTRACT

An information technology system for a health care environment is disclosed. Health care instruments transfer medical data to wireless access points. Mobile user interfaces transfer user instructions to the wireless access points. Identity tags transfer identity information to the wireless access points. The wireless access points transfer the data, instructions, and information to a server system. The server system processes the medical data to generate display data and processes the user instructions to generate control data. The server system transfers the display data and the control data to the wireless access points. The wireless access points transfer the display data to the mobile user interfaces and transfer the control data to the instruments. The user interfaces control their displays responsive to the display data. The instruments operate responsive to the control data.

### RELATED APPLICATIONS

This patent application claims the benefit of provisional patent application 60/295,161 which is hereby incorporated by reference into this patent application.

### BACKGROUND OF THE INVENTION

1. Field of the Invention

The invention is related to the field of information technology, and in particular, to an information technology system that uses wireless communications in a health care environment.

2. Statement of the Problem

Many hospitals have internal information technology systems that include intranets, servers, and computers. Hospital personnel operate the computers to exchange information with the server over the intranet. In addition, hospitals have numerous health care instruments that provide diagnostics or therapy to hospital patients. Typically, these instruments have user interfaces for display and control. Wireless communication technologies have been developed, such as 802.11 and Bluetooth, for relatively short-range wireless communication between devices. Such devices include wireless access points that also communicate over wire line based communication networks. In addition, wireless identity tags have been developed that continually transfer identity information to proximate receivers. Unfortunately, effective information technology systems are lacking that integrate wireless technologies, health care instruments, and user interfaces.

### SUMMARY OF THE SOLUTION

The invention helps solve the above problem with an information technology system for a health care environment. The information technology system effectively integrates wireless technology, health care instruments, and user interfaces. In some examples of the invention, the information technology system comprises a communication network, a server system, a plurality of health care instruments, a plurality of mobile user interfaces, and a plurality of identity tags. The communication network includes a plurality of wireless access points, and the server system is linked to the communication network. The health care instruments are configured to provide medical diagnostics or therapy to individuals and transfer corresponding medical data in first wireless communications to the wireless access points. The mobile user interfaces are configured to transfer user instructions in second wireless communications to the wireless access points. The identity tags are configured to transfer individual identity information in third wireless communications to the wireless access points. The wireless access points are configured to transfer the medical data, the user instructions, and the individual identity information to the server system over the communication network. The server system is configured to process the medical data and the individual identity information to generate display control data. The server system is configured to process the user instructions and the individual identity information to generate instrument control data. The server system is configured to transfer the display control data and the instrument control data to the wireless access points over the communication network. The wireless access points are configured to transfer the display control data in fourth wireless communications to the mobile user interfaces and transfer the instrument control data in fifth wireless communications to the health care instruments. The mobile user interfaces control their displays responsive to the display control data. The health care instruments operate responsive to the instrument control data.

### DESCRIPTION OF THE DRAWINGS

The same reference number represents the same element on all drawings.

FIG. 1 illustrates a health care environment in an example of the invention.

FIG. 2 illustrates an information technology system in an example of the invention.

FIG. 3 illustrates a server system in an example of the invention.

FIG. 4 illustrates the operation of an information technology system in an example of the invention.

### DETAILED DESCRIPTION OF THE INVENTION

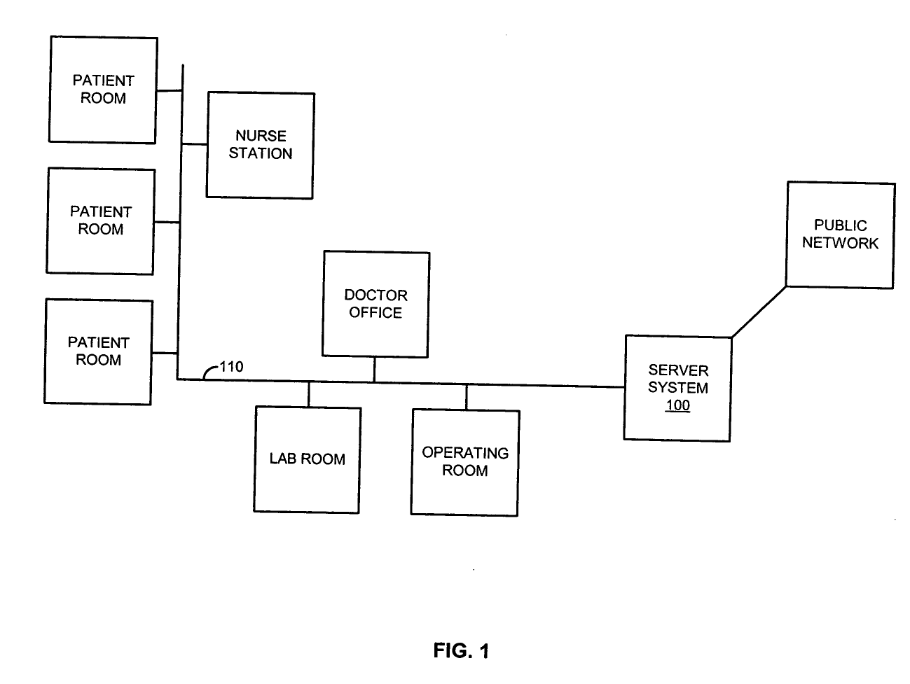

FIGS. 1-4 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 illustrates a health care environment in an example of the invention. The health care environment includes patient rooms, lab room, operating room, nurse station, and doctor office that are all coupled to communication network 110. Communication network 110 is connected to server system 100 that is connected to a public network. The health care environment could be a hospital, medical office, or some other health care facility. The public network could be the Internet, public telephone network, or some other publicly available communication system. In some examples of the invention, the health care environment could include more patient rooms, lab rooms, operating rooms, nurse stations, and doctor offices, but the number is restricted for clarity.

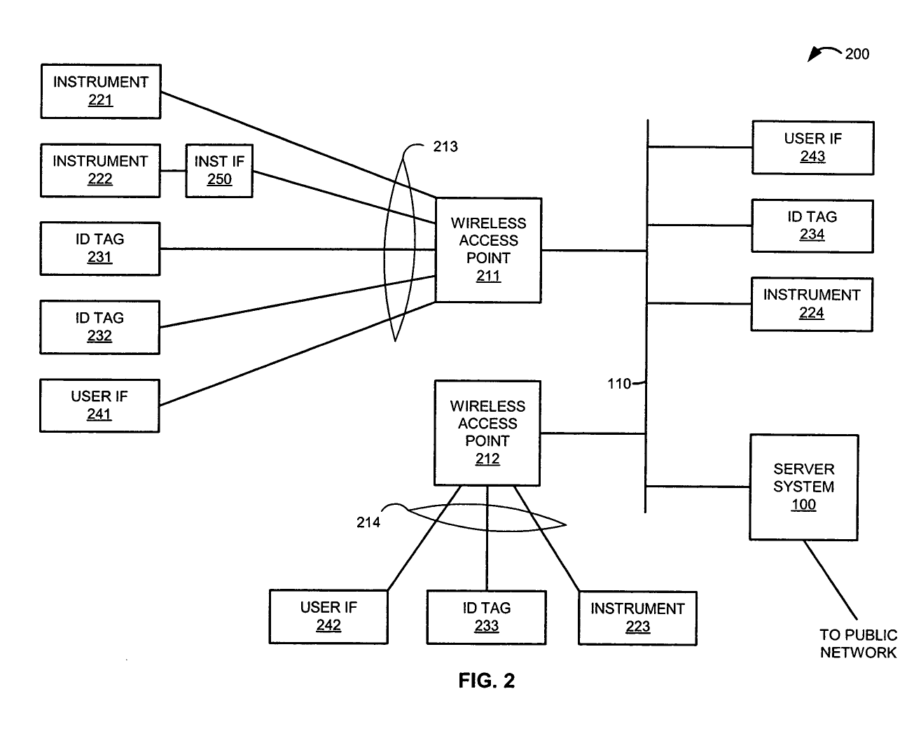

FIG. 2 illustrates information technology system 200 in an example of the invention. System 200 includes server system 100, communication network 110, wireless access points 211-212, instruments 221-224, identification (ID) tags 231-234, user interfaces 241-243, and instrument interface 250. Communication network 110 is coupled to server system 100, wireless access points 211-212, instrument 224, ID tag 234, and user interface 243. Instrument 222 is coupled to instrument interface 250. Wireless communication links 213 transfer wireless communications between wireless access point 211 and instrument 221, instrument interface 250, ID tag 231, ID tag 232, and user interface 241. Wireless communication links 214 transfer wireless communications between wireless access point 212 and user interface 242, ID tag 233, and instrument 223. Based on this disclosure, those skilled in the art will appreciate how to modify and configure existing computer, communication, and medical systems to make information technology system 200.

Wireless access points 211-212 communicate over wireless communication links 213-214 using 802.11, Bluetooth, or some other wireless communication protocol. Wireless access points 211-212 could be located in patient rooms, lab rooms, operating rooms, nurse stations, doctor offices, or other areas of the health care environment. For example, wireless access point 211 could serve a patient room, and wireless access point 212 could serve a lab room. In some examples of the invention, there are many more wireless access points, but the number shown is restricted for clarity.

Instruments 221-224 provide medical diagnostics and therapy with examples including: Respirator, Vital signs monitor, Infusion pump, Ventilator, 0² delivery, Anesthetic delivery, EEG monitor, Feeding therapy, Lab instruments, Blood gas analyzer, Flow cytometer, Automated microbial ID, Glucometer, Hemetology analyzer, Immunoassay system, DNA analysis, Ultrasound, and video and audio equipment. Instruments 221-224 transfer data related to diagnostics, therapy, and instrument performance. Some of instruments 221-224 may also receive information or instructions. Instruments 221 and 223 each include a wireless communication interface.

Instrument 222 is coupled to instrument interface 250 over a connection, such as an RS-232 link. Instrument interface 250 includes a wireless interface and a protocol converter to exchange communications with instrument 222 over the connection and to exchange the communications with wireless access point 211 over wireless communication links 213. In some examples, instrument interface also includes processing and memory circuitry to host applications.

ID tags 231-234 are carried or worn by patients and possibly health care personnel. ID tags 231-234 transfer identity information that allows individual identification. ID tags 231-233 each include a wireless communication interface. ID tag 234 does not have a wireless communication interface, and includes some other interface, such as a card reader or biometric device, that transfers identity information to communication network 110. Thus, the location of individuals, such as patients and health care personnel may be tracked within the health care environment. In some examples, ID tags 231-234 may receive and store information transferred using wireless communications.

User interfaces 241-243 display or otherwise provide information to the user and receive information from their user. User interfaces 241-243 could be computers, personal digital assistants, telephones, terminals, or other devices for interacting with users. User interfaces 241-242 each include a wireless communication interface, and could be mobile devices.

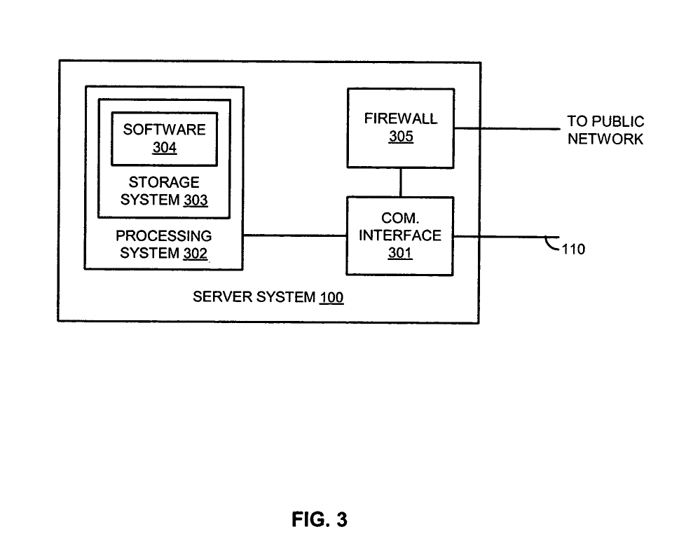

FIG. 3 illustrates server system 100 in an example of the invention. Server system 100 includes communication interface 301, processing system 302, and firewall 305. Processing system 302 includes storage system 303. Storage system 303 includes software 304. Communication interface 301 and processing system 302 are linked together. Communication interface 301 is coupled to communication network 110 and firewall 305. Firewall 305 is coupled to the public network. Server system 100 could be comprised of programmed general-purpose computer equipment and conventional communications equipment, although those skilled in the art will appreciate that programmable or special purpose circuitry and equipment may be used. Server system 100 may use a client server architecture where operations are distributed among a server system and client devices that together comprise elements 301-305.

Communication interface 301 is configured to exchange communications with communication network 110 and firewall 305. Firewall 305 is configured to exchange communications between communication interface 301 and the public network. Firewall 305 is also configured to provide a security barrier for server system 100 against unwanted communications from the public network. Communication interface 301 and firewall 305 could be conventional.

Processing system 302 could comprise computer microprocessors, logic circuits, or some other processing devices. Processing system 302 may be distributed among multiple processing devices. Storage system 303 could comprise a disk, tape, integrated circuit, server, or some other memory device. Storage system 303 may be distributed among multiple memory devices. Processing system 302 retrieves and executes software 304 from storage system 303. Software 304 could comprise application programs, firmware, or some other form of machine-readable processing instructions. When executed by processing system 302, software 304 directs processing system 302 to control server system 100 operation as described herein.

Server system 100, communication network 110, and wireless access points 211-212 are configured to deliver data and instructions to specific individual instruments, user interfaces, or ID tags. In addition, Server system 100 may also transfer the data and instructions to groups and combinations of the instruments, interfaces, and tags.

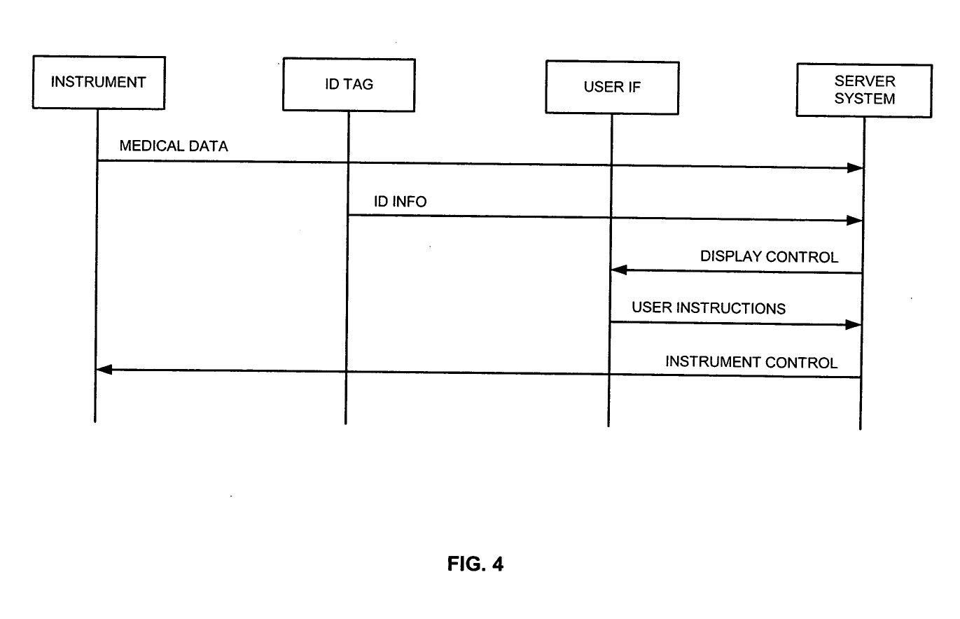

FIG. 4 illustrates the operation of an information technology system in an example of the invention. In the following discussion, communications between the server system and the instrument, identity tag, and user interface occur as described above, but for clarity, the wireless communication links, wireless access points, and communication network are omitted from the discussion. In addition, the following discussion includes only a single instrument, identity tag, and user interface, although similar operations would also occur for other instruments, identity tags, and user interfaces.

On FIG. 4, a health care instrument provides medical diagnostic or therapy to an individual and transfers corresponding medical data to the server system. An identity tag transfers individual identity information for the individual to the server system. The server system processes the medical data and the individual identity information to generate and transfer display control data to a mobile user interface. The mobile user interface controls its display responsive to the display control data. For example, a heart monitor and oxygen delivery instrument may transfer a patient's heart rate to the server system, and a patient ID tag may transfer the patient's ID to the server system. The server system could then transfer a web page indicating the patient's ID and heart rate to a handheld computer for display to a nurse caring for the patient.

The user interface transfers user instructions to the server system. The server system processes the user instructions and the individual identity information to generate and transfer instrument control data to the instrument. The instrument operates responsive to the instrument control data. In the above example, the nurse may operate the handheld computer to transfer an instruction to the server system to increase oxygen delivery to the patient. The server system could then transfer a corresponding instruction to the instrument, and the instrument would increase oxygen delivery to the patient.

Various additional features may be implemented in various examples of the invention.

In some examples of the invention, the server system processes medical data from a first instrument to generate and transfer instrument control data to a second instrument. For example, a pulse oximeter instrument may transfer blood oxygen levels to the server system, and the server system may responsively transfer feedback instrument control data to a ventilator instrument to modify its speed or volume to maintain a desired blood oxygen level. In a similar fashion, an esophageal monitor that detects fluid may transfer a fluid detection alarm indicating fluid back-up in the esophagus to the server system, and the server system may responsively transfer instrument control data to a fluid therapy instrument, such as a feeding tube, to reduce or stop fluid delivery. Likewise, a temperature instrument may transfer a patient temperature to the server system, and the server system may responsively transfer instrument control data to an energy therapy instrument to maintain a desired temperature in a part of the body.

In some examples of the invention, the server system receives and integrates medical data from multiple instruments to generate and transfer display control data to a user interface. The user interface displays the integrated medical data responsive to the display control data. For example, a heart monitor instrument and a separate temperature sensor instrument may respectively transfer heart rate and temperature data to the server system. The server system could then transfer display control data to a handheld computer to display the heart rate and temperature in the same view. In this fashion, the desired data from multiple instruments may be integrated onto a single user display or view. In response to a request from a user interface, the server system could return a menu of diagnostics, therapy, and other information for a patient. The user could select from the menu to create a customized view of the patient's data on their user interface.

In some examples of the invention, an instrument transfers instrument performance data to the server system, and the server system processes the instrument performance data to assess performance of the instrument. For example, a drug delivery instrument may transfer its remaining drug supply, and the server system could assess when an additional drug supply is required. In another example, an in-vitro diagnostic instrument could transfer its reagent levels and cycle times, and the server system could check this data against thresholds to determine when routine maintenance or new reagents are required. In another example, an instrument could transfer the amount of resources, such as a drug, that the instrument uses for individual tests or procedures. The server system could track resource usage against desired thresholds and averages to indicate undesirable performance.

In some examples of the invention, the server system receives and processes individual identity information for an individual to inhibit incorrect user instructions for the individual. For example, if a doctor transfers a user instruction from a user interface to administer a given drug to a patient, but the patient is allergic to the drug, the server system could check the user instruction against the patient's allergy profile to discover the problem, and then inhibit the incorrect delivery of the drug to the allergic patient through prompts or alarms. In addition to checking user instructions, the server system could check instrument control data against the patient's data to inhibit incorrect instrument control data. For example, before transferring instrument control data to increase a ventilator's volume to a patient, the server system could check the age of the patient to prevent blowing out the lungs of a very young patient with an improperly high ventilator volume. In a similar fashion, the server system could check user instructions and instrument control data against a recent patient history to prevent duplication of procedures that were already performed.

In some examples of the invention, the server system transfers software to the instruments, and the instruments operate responsive to the software. For example, multiple instruments could share software to conserve software licensing costs. When a procedure required the software, the server system would download the software to the instrument being used in the procedure, and after the procedure, the software could be removed from the instrument. When another procedure using a different instrument required the software, the server system would download the software to the different instrument, and after the procedure, the software could be removed from the different instrument. The server system could track use of the software for compliance with license terms. The server system could also track use of the software for a particular individual (based on the identity information) to generate billing information for the individual for use of the software.

In some examples of the invention, the server system processes individual identity information to determine that an individual is proximate to a location, and in response, transfers display control data for the individual to a display system at the location—the display system could be a mobile user interface or some other user interface. For example, when a patient enters an operating room for laser eye surgery, the patient's identity tag could transfer the patient's identity to the server system, and in response to the presence of the patient in the operating room, the server system could transfer patient data to a display in the operating room. In response to the determination that the individual is proximate to a location, the server system could also transfer instrument control data for the individual to an instrument at the location. In the above example, the server system could transfer instrument control data for the patient's eye operation to the laser instrument in the operating room. The server system could also transfer a doctor's preferred set-up to an instrument in response to detecting which doctor (wearing an identity tag) is in the operating room to perform the surgery.

In some examples of the invention, the server system could process the medical data and identity information for an individual to generate billing information for the individual. For example, the server system could track diagnostics and therapies provided to an individual based on the patient's proximity to the instruments. This billing information could include amounts of drugs provided, procedures performed, and the amount of time various instruments are used. Software usage could be tracked in a similar fashion. If health care personnel also have identity tags, then the presence of doctors and nurses in proximity with the patient could be tracked by the server system and used for billing purposes.

In some examples of the invention, the server system is configured to transfer additional display control data to a public communication network. For example, the server system could provide web pages having data from multiple instruments over the Internet to a doctor at a remote location. The server system could also receive additional user instructions from a public communication network. For example, the remote doctor viewing the web pages could transfer user instructions over the Internet to the server system.

In some examples of the invention, the some of the health care instruments include docking stations for some of the mobile user interfaces. By placing the user interface into the docking station, direct communications between the instruments and the portion of the user interface are established. For example, a PDA could be placed in the docking station of a heart monitor, and the heart rate could be displayed on the PDA using the direct communications instead of communication through the server system.

In some examples of the invention, the server system processes the medical data to generate individual data. The server system transfers the individual data to the wireless access points over the communication network, and the wireless access points transfer the individual data to the identity tags. The identity tags receive and store the individual information. For example, an instrument could transfer medical data to the server system indicating that a drug dose has been delivered, and the server system could transfer this information for recording on the identity tag. In this fashion, the patient's information could be recorded on the tag worn by the patient. Thus, any system that can read the patient's identity tag could access the information.

In some examples of the invention, the server system is configured to test performance of the communication network, the wireless access points, and/or the health care instruments. For example, the server system could periodically transfer test information through the communication network and wireless access points to a test device that responds with additional test information, so the server system could measure transfer accuracy and speed.

In some examples of the invention, the server system includes a redundant back-up system. For example a redundant server system could be placed at a different physical location and be invoked if the primary server system fails.

In some examples of the invention, some of the instruments may be faceless meaning that the instrument has no integrated user interface to control its medical systems or to display its diagnostic or therapy data. The faceless instrument may include a docking station for the mobile user interfaces, such as PDAs, to provide a direct means of display and control. The faceless instrument may include a connectivity indicator to indicate if communications with the server system are operational.

In some examples of the invention, some elements of the information technology system could be located in a patient room to primarily serve systems and devices in the room. For example, a patient room could include a server system and wireless access point coupled together. The room could also include instruments, instrument interfaces, ID tags, and user interfaces that communicate with the server system through the wireless access point. In some cases, the server system and wireless access point could be integrated within an instrument or user interface. The server system could also have connections and interaction with other systems that are outside of the room.

In some examples of the invention, a patient room could have a memory device coupled to the wireless access point and capable of storing information from the instruments, server system, user interfaces, and ID tags. The memory device could maintain an in-room record of activities in the room. The memory device could be integrated within an instrument, user interface, bed, computer ID tag, or some other device in the room.

1. An information technology system for a health care environment, the system comprising:
a communication network including a plurality of wireless access points;
a server system linked to the communication network;
a plurality of health care instruments configured to provide medical diagnostics or therapy to individuals and transfer corresponding medical data in first wireless communications to the wireless access points;
a plurality of mobile user interfaces configured to transfer user instructions in second wireless communications to the wireless access points;
a plurality of identity tags configured to transfer individual identity information in third wireless communications to the wireless access points;
wherein the wireless access points are configured to transfer the medical data, the user instructions, and the individual identity information to the server system over the communication network;
wherein the server system is configured to process the medical data and the individual identity information to generate display control data, process the user instructions and the individual identity information to generate instrument control data, and transfer the display control data and the instrument control data to the wireless access points over the communication network;
wherein the wireless access points are configured to transfer the display control data in fourth wireless communications to the mobile user interfaces and transfer the instrument control data in fifth wireless communications to the health care instruments; and
wherein the mobile user interfaces control their displays responsive to the display control data and the health care instruments operate responsive to the instrument control data.

2. The system of claim 1 wherein the server system is configured to process the medical data from a first one of the health care instruments to generate the instrument control data for a second one of the health care instruments.

3. The system of claim 1 wherein the server system is configured to integrate the medical data from a group of the health care instruments providing the medical diagnostics or therapy to a single one of the individuals, and one of the mobile user interfaces is configured to display the integrated medical data responsive to the display control data.

4. The system of claim 1 wherein at least some of the health care instruments are configured to transfer instrument performance data in the first wireless communications to the wireless access points, the wireless access points are configured to transfer the instrument performance data to the server system over the communication network, and the server system is configured to process the instrument performance data to assess performance of the health care instruments.

5. The system of claim 1 wherein the server system is configured to process the individual identity information for one of the individuals to inhibit incorrect user instructions for the one individual.

6. The system of claim 1 wherein the server system is configured to process the individual identity information for one of the individuals to inhibit incorrect instrument control data for the one individual.

7. The system of claim 1 wherein the server system is configured to transfer software to the wireless access points over the communication network, the wireless access points are configured to transfer the software in the fifth wireless communications to the health care instruments, and the health care instruments operate responsive to the software.

8. The system of claim 1 wherein the server system is configured to process the individual identity information to determine that one of the individuals is proximate to a location, and in response, to transfer the display control data for the one individual to a display system at the location.

9. The system of claim 1 wherein the server system is configured to process the individual identity information to determine that one of the individuals is proximate to a location, and in response, transfer the instrument control data for the one individual to one of the health care instruments at the location.

10. The system of claim 1 wherein the server system is configured to process the individual identity information for one of the individuals and the medical data to generate billing information for the one individual.

11. The system of claim 1 wherein the server system is configured to transfer additional display control data to a public communication network.

12. The system of claim 1 wherein the server system is configured to receive additional user instructions from a public communication network.

13. The system of claim 1 further comprising a plurality of instrument interfaces configured to provide an interface between the wireless access points and additional health care instruments without wireless communication capability.

14. The system of claim 1 wherein at least a portion of the health care instruments include docking stations for at least a portion of the mobile user interfaces to provide direct communications between the portion of the health care instruments and the portion of the mobile user interfaces.

15. The system of claim 1 wherein the server system is configured to process the medical data to generate individual data and transfer the individual data to the wireless access points over the communication network, wherein the wireless access points are configured to transfer the individual data in sixth wireless communications to the identity tags, and the identity tags are configured to store the individual information.

16. The system of claim 1 wherein the server system is configured to test performance of the communication network and the wireless access points.

17. The system of claim 1 wherein the server system is configured to test performance of the health care instruments.

18. The system of claim 1 wherein the server system includes a redundant back-up system.

19. The system of claim 1 wherein the display control data comprise web pages.

20. The system of claim 1 further comprising a memory device located in a patient room, coupled to one of the wireless access points, and configured to receive and store at least portions of the medical data, user instructions, individual identity information, display control data, and instrument control data transferred in the patient room.
